(19) United States
(12) Patent Application Publication
(10) Pub. No.: US 2003/0195806 A1
(43) Pub. Date: Oct. 16, 2003

(54) Manufacturer's coupon ordering system

(75) Inventors: James W. Willman, Grand Rapids, MI (US); Carol A. Passero, Springfield, VA (US); Simon A. Boddy, Grand Rapids, MI (US); James P. DeLapa, Grand Rapids, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: Ad Response MicroMarketing Corporation, Grand Rapids, MI

(21) Appl. No.: 10/422,490

(22) Filed: Apr. 24, 2003

Related U.S. Application Data
(63) Continuation of application No. 09/432,561, filed on Nov. 3, 1999, now abandoned.
(60) Provisional application No. 60/107,950, filed on Nov. 12, 1998.

(51) Int. Cl. G06F 17/60

(52) U.S. Cl. 705/14

(57) ABSTRACT

A manufacturer's ordering system provides manufacturers of packaged goods with analytical tools for conducting analysis on consolidated data of consumer purchase patterns. The consumer purchase data are consolidated by product categories and/or subcategories and/or freely defined geographical areas in which the manufacturer is interested. The manufacturer thus may specify coupon print content, audience selection criteria, geographical area and time frame for coupon distribution without the requirement of interaction with various print companies and sales representatives. The coupon discount value may be varied in accordance with the different groups of targeted customers. The promotional selections may be made via electronic media, such as a global computer network or internet connection, and may then be provided to a coupon distribution system via a similar connection. Preferably, the consolidated data are accumulated from point of sale devices at retail stores and preferably from kiosk usage at the store. Preferably, the data are continuously collected, such that the manufacturers base their promotional decisions on substantially real time data.

This non-provisional patent application claims priority from U.S. Provisional Application Serial No. 60/107,950, filed Nov. 12, 1998, which is hereby incorporated herein by reference.

### BACKGROUND OF THE INVENTION

This invention relates generally to coupon generation and distribution systems and, more particularly, to a manufacturer controlled coupon system, which is based upon current product movement, sales information, and related data.

Coupons may be provided to consumers for discounts on various goods. The coupons may be provided as free-standing inserts in newspapers or the like, mailings, or even via online services, such as website postings and the like, whereby consumers select the coupons online, proceed to the designated store, purchase the items, and then receive the appropriate face value discount at that time, or coupons good on their next shopping trip. Typically, packaged goods manufacturers plan the promotional content and time period of the coupons or discount offers for their goods in response to market data trends and discussions or negotiations with printing and/or distributing companies. Once the manufacturers develop their general promotional plans, negotiations are held with sales or marketing representatives of the coupon printing and distribution companies to finalize the promotional details and agree upon the cost of the promotion to the manufacturer. These negotiations typically occur once a year and determine the manufacturer's promotional strategy for the entire year. Once the manufacturer selects the promotional content and time periods for their offers, payment is made to the printing companies in advance for the printing and distribution of the coupons. This may be a substantial up-front fee, especially if the manufacturer requests exclusivity during the selected promotional periods.

To date, the packaged goods manufacturers base their decisions on data from various sources, such as IRI, Nielsen, and other product movement information sources sales information from retailers, demographic information (such as average income, home ownership, family size and the like) from the government, regional and national surveys, and the like. However, none of this information permits the manufacturers to view their product promotional periods in a real time atmosphere, since much of the information is from the previous year or even earlier. Furthermore, the manufacturers typically have to pay access fees for this information. Another concern with the data available to the manufacturers is that the data typically are national in scope, and delineating the data further to the regional level causes further delays, which makes it difficult to determine the best regional promotional offer. This is a concern to the manufacturers because in order to achieve the greater return on their promotional dollars, a more customer specific marketing approach should be implemented in which the promotional dollars are better directed to the consumers who are more likely to use the discounts to purchase the manufacturers' brands and thus recognize the cost savings. Because the data now available to manufacturers are often neither current nor regionally categorized, it is difficult for the manufacturers to achieve a consumer direct marketing approach in order to further achieve a greater return on their promotional dollars spent.

Another concern with the conventional coupon generation approach is that retail stores are also not part of the planning equation. The retail stores would prefer greater flexibility in their participation of the offers, since they are more in tune with the product movement within their particular stores or regions. In order to achieve the desired promotional offers, some retailers today are now large enough to leverage the packaged goods manufacturers. These retailers may charge fees to the manufacturers to put their products on the shelves or to advertise or offer discounts for the product in the retailers fliers or catalogs. This approach may also be very costly to the packaged goods manufacturers, and may even preclude smaller manufacturers from being able to put their products on the shelves of some of the retailers, since the associated costs may be excessively high.

Furthermore, currently approximately 98 percent of coupons printed, such as free standing inserts and the like, are not redeemed by consumers. This results in excessive waste of money and paper. The coupon/discount offer processes are thus environmentally unfriendly and highly costly to the packaged goods manufacturers and are not well-targeted to the specific consumers. Additionally, the promotional decisions are not based on real time analysis of product movement and sales information. Because the current approach does not typically include the retailer and/or the consumer in the decision making processes, the manufacturers cannot achieve the desired consumer direct marketing, and thus many of the printed coupons are wasted such that the manufacturers do not realize as great a return for their promotional dollars as they would prefer.

Therefore, there is a need in the art for a marketing approach which is more consumer directed and which is based upon recent or real time data. The approach should also reduce costs to the product manufacturers, in order to allow them a better return for their promotional dollars spent. By providing a better return to the manufacturers, additional offers, or maybe even greater discounts, may be offered by the manufacturers, which would further be beneficial to the consumers. Furthermore, by basing the promotional decisions on recent and consumer directed data, the consumers are more likely to get discounts and offers which they will be more likely to utilize.

### SUMMARY OF THE INVENTION

The present invention is intended to provide a coupon selection and generation system which allows a manufacturer of goods or products access to planning tools, which include purchase related data for analysis by the manufacturer, with which the manufacturer may select promotional offers and time periods based upon substantially real time data pertaining to particular stores or regions. The purchase data may be categorized for analysis by products or category of products, or any other relevant groups or categories. The present invention thus provides a more consumer-directed product promotion approach which is less costly to the manufacturers. This approach further provides product discount offers which are more desirable by both the retailers and the consumers.

According to an aspect of the present invention, a coupon generating system comprises analysis tools which provide consumer data to at least one product manufacturer, and promotional selection tools. The product manufacturer can analyze the consumer data with the analysis tools and select a promotional content and a promotional period with the promotional selection tools in response to the analysis via electronic media. Coupons incorporating the promotional content are then distributable to the consumers via a coupon distribution system during the promotional period. Preferably, the coupon distribution system comprises a kiosk located at one or more retail establishments. Preferably, the analysis tools provide consumer data which are consolidated from multiple retail establishments within a district or a geographical region.

According to another aspect of the present invention, a computer implemented system for generating coupons comprises a coupon distribution system, and at least one computer server comprising a database for receiving individual purchase data associated with transactions at one or more retail establishments. At least a portion of the individual purchase data is accessible to at least one product manufacturer. A coupon content and promotional period are selectable by the product manufacturer via electronic media in response to analysis of the purchase data. The coupon content and promotional period are then electronically communicable to the coupon distribution system, which is operable to provide the selected coupons to the consumers during the selected promotional period. Preferably, the individual purchase data are collected on multiple retail servers associated with the particular chain or geographical region. Preferably, the data on all of the retail servers are consolidated and categorized for access by the manufacturers via promotional analysis and selection tools.

These and other objects, advantages, purposes and features of this invention will become apparent upon review of the following specification in conjunction with the drawings.

### BRIEF DESCRIPTION OF THE DRAWINGS

FIG. 1 is a block diagram of the coupon generating system according to the present invention;

FIG. 2 is a flowchart of a coupon generating system according to the present invention;

FIG. 3 is a flowchart of the data collection and promotional selection processes in accordance with the present invention;

FIG. 4 is a flowchart of processes performed by a retail server useful with the present invention;

FIG. 5 is a flowchart of processes performed by a central server useful with the present invention; and

FIGS. 6 and 6A are a flowchart of an analysis and promotional entry process performed by a product manufacturer in accordance with the present invention.

### DESCRIPTION OF THE PREFERRED EMBODIMENTS

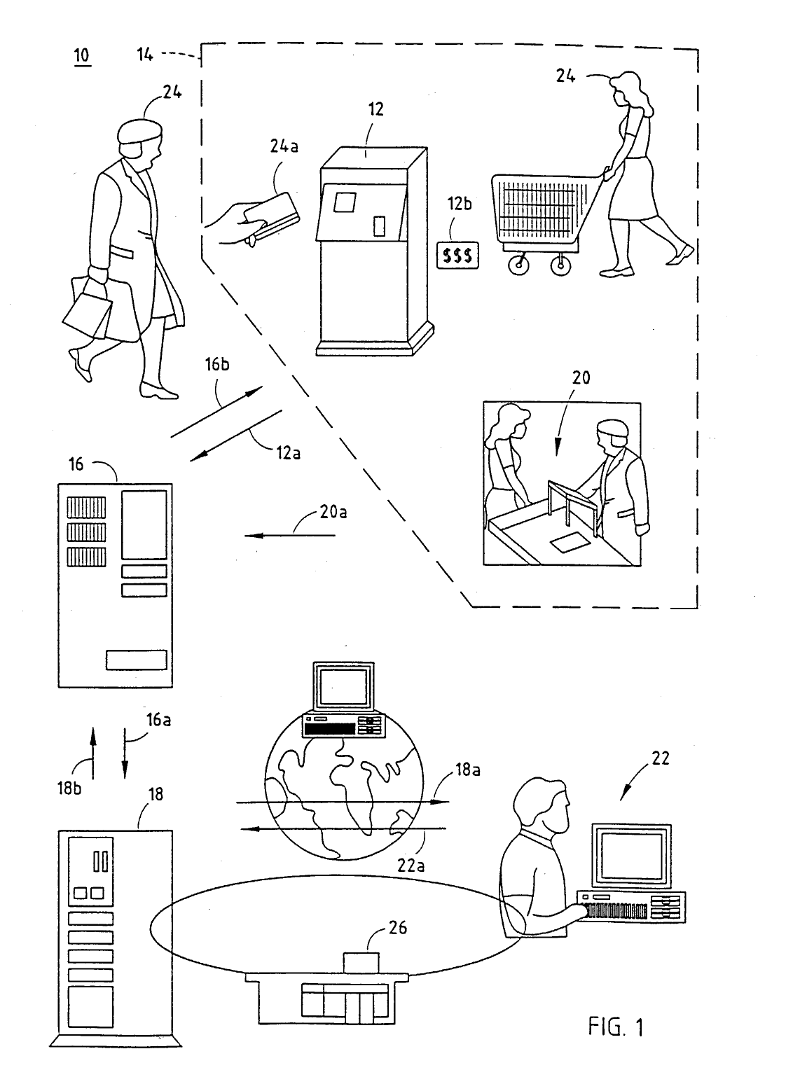

Referring now specifically to the drawings, and the illustrative embodiments depicted therein, a coupon selection and generation system 10 comprises a coupon distributor or coupon distribution system 12, a retail database or server or data collection system/engine 16, and a central server 18 (FIG. 1). Coupon distribution system 12 may be a kiosk of the type disclosed in commonly assigned co-pending patent application Ser. No. 08/713,205, filed Sep. 12, 1996 by James P. DeLapa et al., a point-of-sale dispenser of the type disclosed in U.S. Pat. No. 4,723,212, issued to Mindrum et al. on Feb. 2, 1988, an internet distribution system of the types disclosed in commonly assigned U.S. patent application Ser. No. 09/130,286, filed Aug. 6, 1998 by DeLapa, or in “Clicking Coupons On-Line Has a Cost: Privacy,” written by Paulette Thomas and published in The Wall Street Journal, page B1, on Jun. 18, 1998, the disclosures of which are hereby incorporated herein by reference. Coupon distribution system 12 could also distribute coupons in the mail or via free-standing inserts in newspapers or the like, without affecting the scope of the present invention. Each of the coupon distribution systems may be associated with a particular chain of stores, a district or region of a larger chain of stores, or a particular geographical region and may be controlled by, operated by, or associated with a single retail server. Purchase data may be collected from a point of sale (POS) device 20 located at a retail store 14, while coupon issuance data may be collected from a kiosk at the store. The purchase data and issuance data preferably are transferred at 20a from the POS device 20 and/or at 12a from the kiosk to the retail server 16 for collection on a retail database associated therewith. Coupon generating system 10 may combine multiple retail servers, which are associated with different chains of stores, or different regional areas or districts of one or more retail chains. The purchase data are transferred at 16a from each retail server 16 to central server 18, where the data are consolidated into a single database and formatted for analytical purposes. The data may be consolidated and categorized by products purchased or by categories of products purchased, and/or other relevant categories. Central server 18 is accessible to licensed product manufacturers 22. The product manufacturers 22 may access the database at 18a via any known means, such as via an electronic media connection, such as a global network or internet/website connection, a wide area network, a telephone link, or an exchange of physical media, such as a diskette or the like. The manufacturer 22 may analyze and review the consolidated purchase data via analysis tools provided by the central server host and determine and select specific promotional periods and discount offers at 22a for the promotion of various products or categories or subcategories of products which are offered for sale by the manufacturer. The selected promotional content and time periods are transferred at 18b from the central server 18 to the appropriate retail server 16, whereby the coupon information may be transferred at 16b to the coupon distributor 12 at the onset of the selected promotional period for distribution of the coupons. By providing the manufacturers with access to analysis and promotional set-up tools, the manufacturers will be better able to target their promotions and quickly implement the desired promotions. This may be accomplished without lengthy negotiations with coupon print and distribution representatives, and further avoids the potentially high upfront reservation and printing costs for the particular promotions.

Preferably, the coupon distribution system 12 is a kiosk positioned at one or more retail establishments 14, preferably near an entrance thereof. A user 24 then may scan their user identification card 24a, such as a store member card, club card, credit card, or the like at kiosk 12, and receive coupons 12b or offers available from participating manufacturers during that time period. The coupons distributed are preferably immediately redeemable at the store during that particular shopping trip or may be used at any other time during their active promotional period. The consumer then purchases goods from the store using the coupons. Data pertaining to each consumer's purchase transaction are then recorded at the POS device 20. Retail server 16 collects data pertaining to coupon print and/or distribution and coupon redemption and purchase transactions. The purchase and coupon data are then transferred to central server 18. After the promotional period is complete, the manufacturer 22 may be invoiced for the number of coupons printed, preferably using electronic media or any other known invoicing means. The electronic media may also be a reliable source of proof of performance. The manufacturers may then submit payments to the central server host, such as Ad Response Micromarketing, who in turn reimburses the retailer(s), such as the retail headquarters 26 or district headquarters or the like, for the kiosk participation fee or other participation fees associated with other coupon distribution systems. The redeemed coupons are submitted to a clearing house (not shown), which then invoices the manufacturer for the redemption value of the coupons and handling fees, as is known in the art.

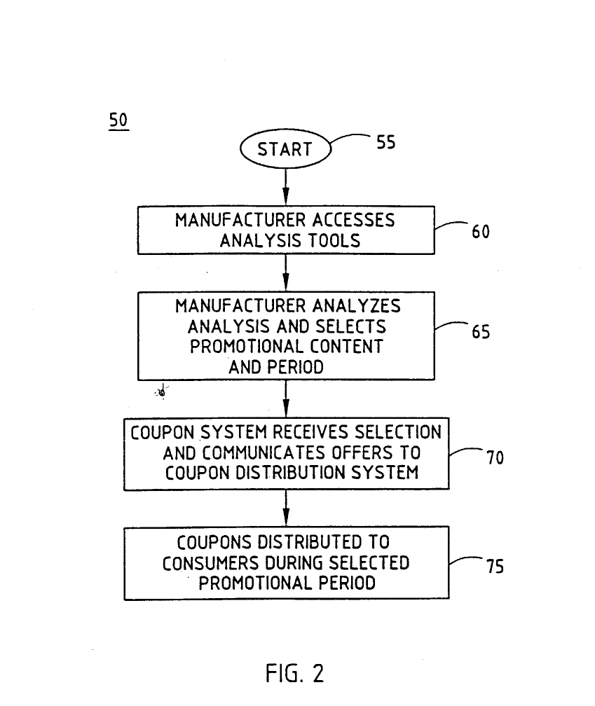

Referring now to FIG. 2, a coupon generation process 50 associated with coupon system 10 starts at 55. The manufacturer or manufacturers access the analysis tools at 60. Preferably, the manufacturers access the analysis tools via electronic media, but the tools may be accessible via other known means. The manufacturer reviews the desired analyses and selects an appropriate promotional content and time period at 65. The coupon system 10 receives the selections and communicates the offers to the coupon distribution system at 70. The coupons are then distributed to consumers during the selected promotional period at 75 and may be immediately redeemable by the consumer. The coupon distribution system may be any known coupon distribution means.

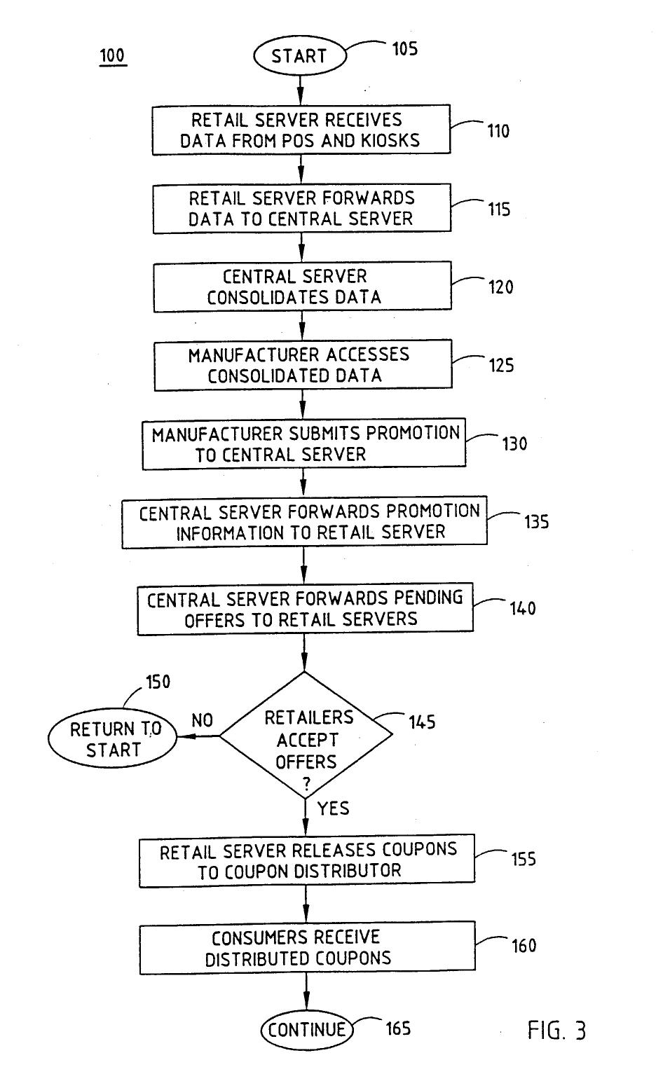

Referring now to FIG. 3, a preferred embodiment of coupon system 10 is shown as a process 100 which starts at 105. The retail server receives coupon issuance and/or redemption data and purchase data from the point of sale devices and maybe kiosks associated with the server at 110. The retail server forwards or transmits the data to the central server at 115. The central server then consolidates and reformats the data for analysis by the licensed manufacturers at 120. The licensed manufacturers may then access and review and/or analyze the consolidated data at 125. The manufacturer then defines and submits the desired promotional offer and promotional time period to the central server at 130. The central server then forwards the promotional information to the individual retail servers at 135. This is preferably done approximately two to three weeks in advance of the promotional period in order to allow the individual retail stores to stock their shelves accordingly. At the onset of the selected promotional time period, the central server forwards pending coupon offers to the retail servers at 140. The individual retailers then accept or decline the offers at 145. If the retailer declines the offer at 145, the process returns to start at 150, and the rejection information is communicated back to the central server and to the manufacturer. If the retailer accepts the offers at 145, then the retail server releases the coupons and offers to the coupon distribution system or systems at 155. Consumers may then scan their cards at kiosks to receive the distributed coupons, or may otherwise receive the coupons through other known coupon distribution systems at 160. The process then continues at 165.

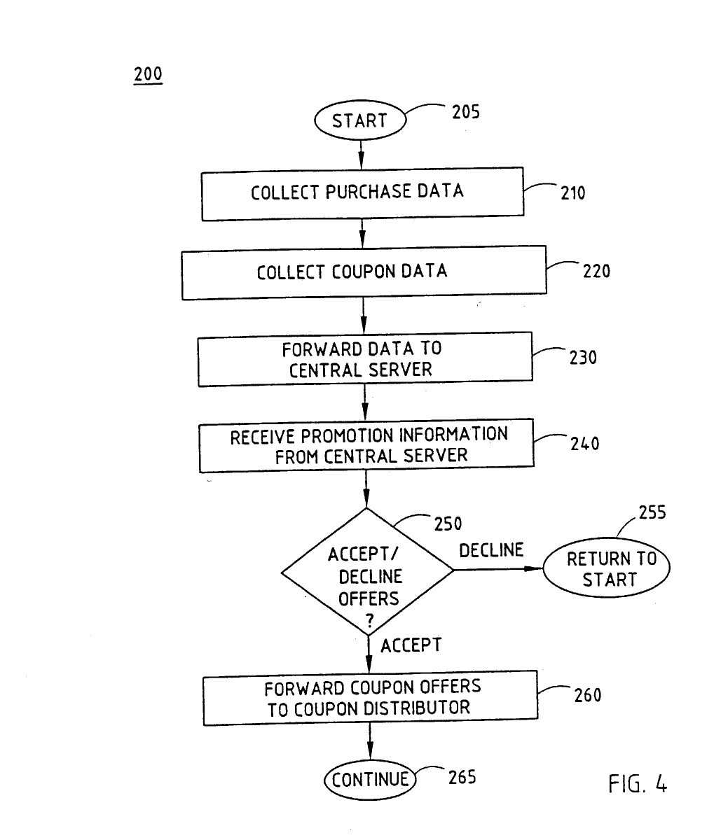

Referring now to FIG. 4, a retail server process 200 starts at 205. Retail server 16 may serve or communicate with several individually or separately owned stores within a geographical region, several stores within a larger retail chain, or several stores within a district or region of a larger retail chain. The retail server may be located at the chain stores' retail headquarters or may be otherwise located for access by one or more of the separately owned stores. The retail servers collect purchase data and coupon usage data from POS systems at each associated retail store at 210. The retail servers may also collect kiosk usage and coupon issuance data from kiosks at each associated retail store or may otherwise receive coupon data from other coupon distribution systems at 220. The data collected may be any form of consumer or purchase data, including kiosk usage data, coupon issuance data, coupon redemption data, product purchase data, which preferably includes categories and subcategories of the particular items purchased, or any other information which may be obtainable at the kiosk or POS device or other data collection device or service. Coupons provided by the system of the present invention may include consumer and coupon identification codes to facilitate tracking of coupon usage by the individual consumers, similar to the coupon systems disclosed in commonly assigned U.S. Pat. No. 5,353,218, issued Oct. 4, 1994, the disclosure of which is hereby incorporated herein by reference. Preferably, however, coupons bear an identification of only the product discount offer. The collected data may be further manipulated to show product movement for kiosk card users versus non-card users, and may even be able to identify customers which use two or more shopping cards at two or more different retail establishments, in order to be able to combine that individual's purchase data as a single consumer. The purchase and coupon data from the POS systems and kiosks are communicated to the central server at 230.

After the manufacturer has selected the promotional content and time period for their particular offers via communications with the central server, the retail servers receive the promotion/offer information from the central server at 240. The retail stores may then accept or decline the offer at 250. Preferably, the offers are only declinable by a retail store if the store cannot adequately stock their shelves with the discounted product, although other “for cause” reasons may be justifiably submitted by the retail stores, without affecting the scope of the present invention. If the offer is not accepted, the process 200 returns to the start at 255. If the offer is accepted at 250, the retail server communicates the coupon offers to the associated coupon distribution systems at 260 and the process continues at 265. Although shown as a flowchart with individual and sequential steps and processes, it should be noted that each of the processes 210, 220, and 230 are ongoing and preferably substantially continuous processes, whereby data are collected and communicated to the central server continuously or on a daily basis or any other periodic time interval, regardless of the promotions or offers received by the retail servers from the central server.

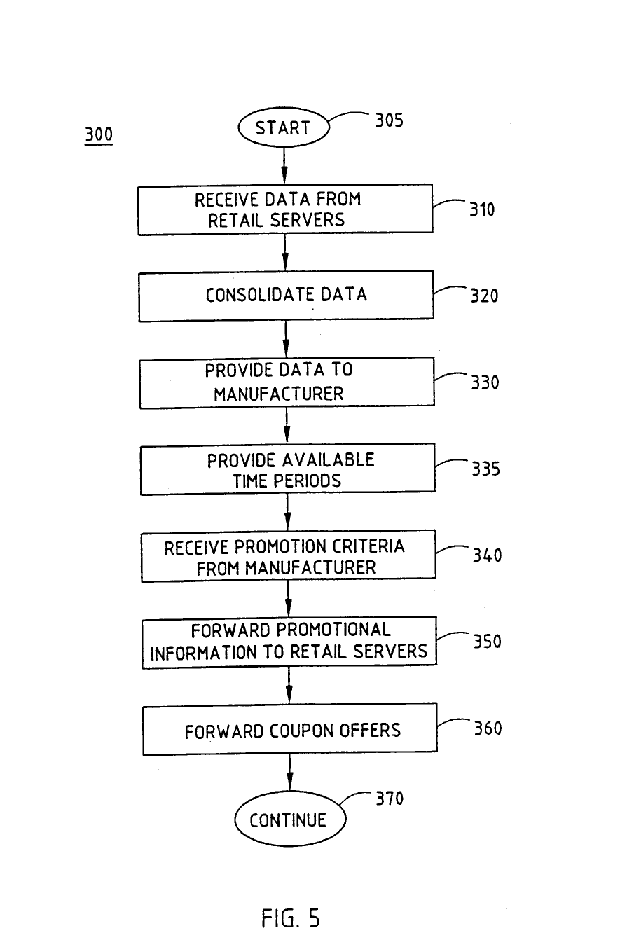

Referring now to FIG. 5, a central server process 300 is shown which starts at 305. Central server 18 receives and accumulates the purchase data from each of the individual retail servers 16 at 310. The collected data for all of the retail stores are preferably consolidated by specified criteria into a single database and reformatted at 320 for analytical purposes, such that the data are easily accessible by packaged goods manufacturers' marketing personnel or the like, for analysis and determination of the promotional offers and time periods. Accordingly, the data may be merged and reformatted to apply to a group of stores in a geographical region and/or a district of a larger chain store to communicate purchase data to the manufacturers which relate to the particular geographical region in which they are interested. The data are also reformatted according to various criteria. For example, the data on the central server may be organized or categorized by the participating retail stores or by geographical location information. The data may further be broken down by purchase data for a calendar week, or other time period, or a particular product or category of products, or for a total market basket value range of goods purchased in a single shopping trip. The products or items may be further categorized under product category relationships, such as those published by Information Resources or A. C. Nielsen or other sources of such information. The goods purchased may be shown as total units sold to all customers or total units sold to cardholder customers only or any other relevant category. The data preferably also may convey the total coupons issued by the coupon distribution systems and the total number of issued coupons which are redeemed by consumers. All of the data categories may be subcategorized under cardholder data and non-cardholder data. The coupon tracking may be further categorized under each particular item and under the family code portion of the coupon UPC code as provided by the manufacturer. This further eases analysis of consumer purchasing trends. Preferably, the data are merged such that the individual transactions are no longer identifiable, since the manufacturers are interested in the overall purchase trends of the area and not in the individuals or, in other words, the manufacturers are only interested in aggregated numbers or figures, and not in the individual purchase transactions. This also reduces individual consumer's privacy concerns, since their names and other personal information are thus withheld from the manufacturers.

The consolidated data are licensed and provided to one or more manufacturers. The consolidated data may then be accessed by the manufacturers, preferably via electronic media, such as an internet connection or the like, at 330. After the manufacturer has selected promotions based on the analyzed data, the central server then provides the user with a list of available promotional periods for their particular category or subcategory at 335. After the manufacturer has selected and submitted their promotional content and time period for their promotional offer, the central server receives the promotional criteria from the user at 340. The product offer information is then forwarded to the retail servers at 350 in advance of the promotional period, in order to allow the retailers time to stock their shelves or to decline participation with the offer. At the onset of the promotional period, the coupon offers are then also forwarded to the retail servers at 360 for distribution by the retail servers and the coupon distribution systems. The process 300 then continues at 370. Although shown as separate and sequential steps in process 300, the central server preferably continually or periodically receives data from the retail servers at 310, consolidates the data at 320, and makes the data accessible to licensed users at 330, regardless of whether individual specific promotional offers are being submitted by one or more licensed manufacturers.

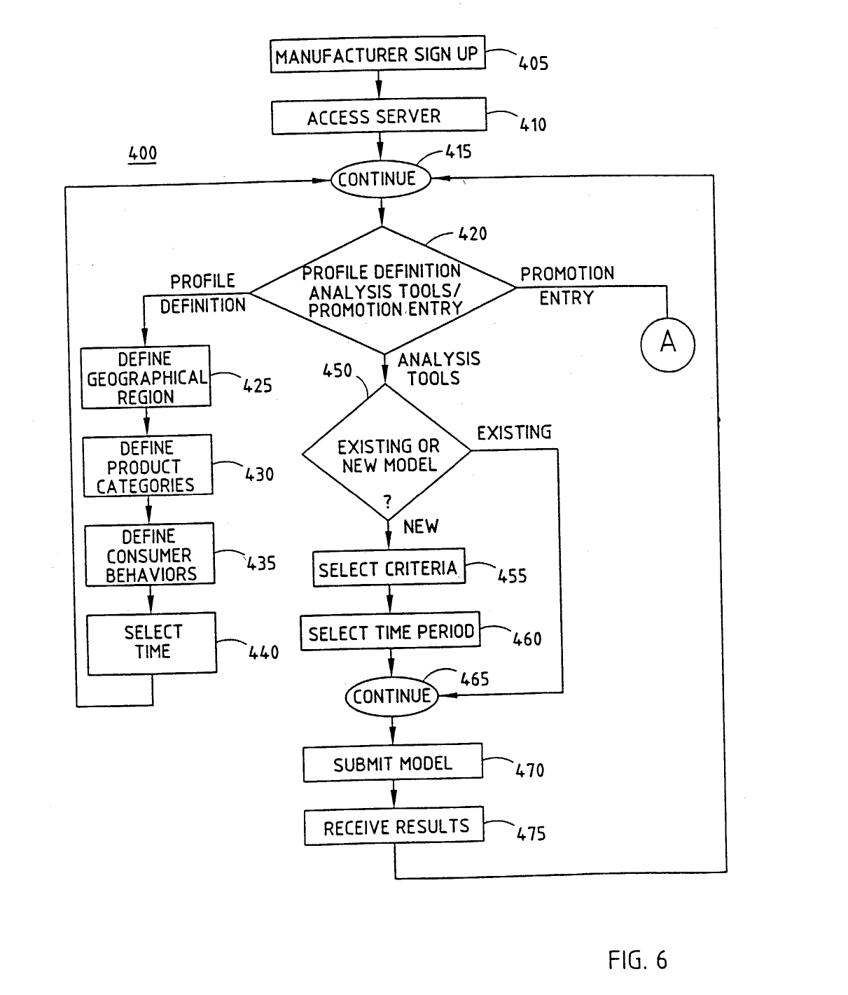

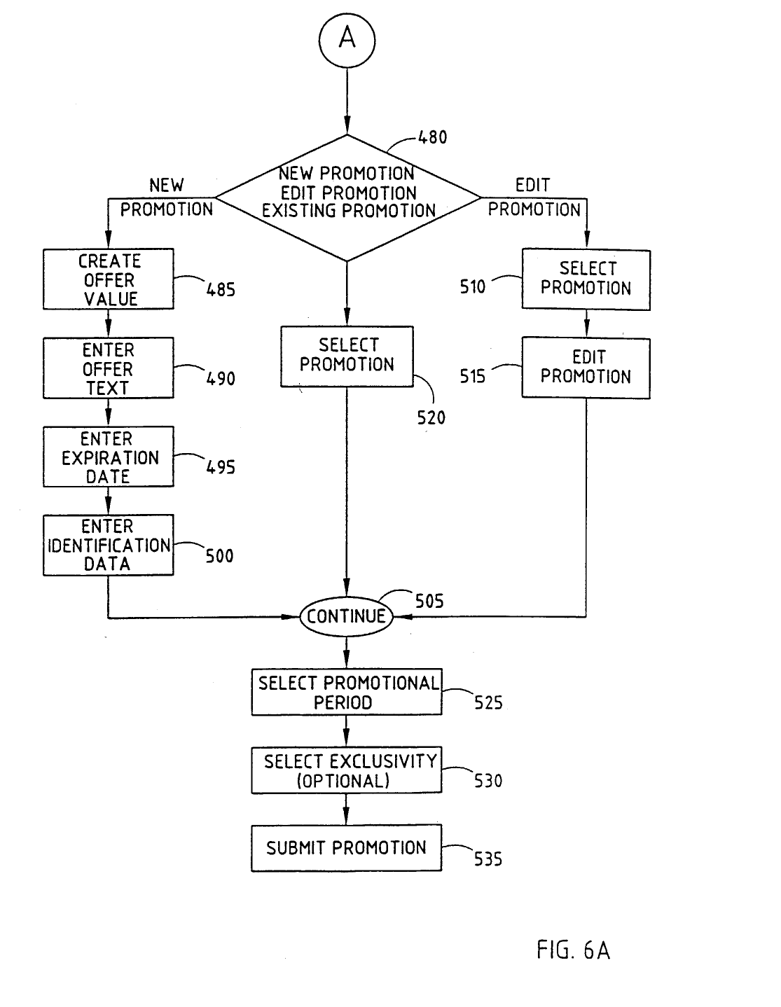

Referring now to FIGS. 6 and 6A, a manufacturer analysis and selection process 400 performed by the licensed manufacturers is shown which starts with the manufacturer signing up with the central server at 405. The manufacturers, such as marketing personnel or managers of the various packaged goods manufacturers or distributors, contract with the central server host to obtain the right to access the central server. At that time, they may specify the product categories under which they will collect data, perform analyses, and target their promotional offers. The product categories and subcategories available for specification are preferably those defined and published by Information Resources, A. C. Nielsen and the like. In addition to this information, the manufacturers preferably further provide clearing house information and select how many individual user accounts they will require, such that more than one manager or marketing personnel may access the database and submit promotions to the central server. The manufacturer then accesses the server, such as by logging onto the network site at 410 and continues at 415. The network site may be associated with a local network or a global computer network, which the manufacturer may access via a network or internet connection. When an individual manufacturer personnel or employee first logs on with the manufacturer's group account, they will preferably establish their own logon identification which will link them to a particular profile. Each profile lists the items of data desired to be analyzed for targeting promotions, and may comprise a defined set of geographical regions, a default product category or subcategory, particular consumer purchase behavior and the like.

The user may select a profile definition, analysis tools, or promotional entry at 420. If the user selects a profile definition at 420, the user defines the targeted geographical regions of the profile at 425. The geographical region may be outlined on a map by selecting a set of points which define an area of interest or by other means for defining a region. The mapping capability may be supplied by off shelf components such as Moving Map by Global Majic Software, MAPS 3000 by CheckPoint Technologies, or the like. The user may further define product categories and subcategories at 430. The categories and subcategories selected may be selectable from those subscribed to by the manufacturer in the initial user contract. The user may further define consumer behaviors at 435. The consumer purchase behavior defines a purchase behavior which is to be targeted by the manufacturer. For example, the manufacturer may target a “loyal buyer,” which may buy their product in the selected category five times during a four week period, a “switcher buyer,” which may buy a product in the category from more than one brand over a twelve-week period, a “non-buyer,” for which there is no data available or which may buy in the category only once during a 52 week period, and/or any other relevant buyer category. Furthermore, the discount value of the coupon may be varied for each of these groups in accordance with the principles disclosed in commonly assigned U.S. Pat. No. 5,822,735, issued Oct. 13, 1998, the disclosure of which is hereby incorporated herein by reference. The user may then define selected timeframes at 440. Additional variables may be selected by the manufacturer, such as the time frame for analysis, purchase frequency, purchase amount, product identification, category and/or subcategory identification, and coupon redemption. Preferably, the profile may be modified at any time in the future to further focus or broaden the area of analysis. The user may select other profile criterion and then continue at 415, or quit or log off the network.

After the individual profiles have been defined, the user preferably may set up an analysis model which comprises a set of queries that are defined by the user. The queries are selected from one or more items listed in the user's profile. Each analysis model may be given an identifying label or name, so that the user may later reference it for re-use at a later date. If the user selects the analysis tools at 420, then the user further selects an existing model or creates a new model at 450. If the user elects to create a new model at 450, then the user selects criteria or queries from the profile, or may select new criteria, at 455. The queries may include a particular geographical region, a category/subcategory of the desired products, a timeframe to base the analysis on, and/or consumer purchase behavior and/or other relevant analytical queries. The queries may be selected from the lists stored in the user's profile, or may be newly defined and stored in the profile for later use. The user then selects the time frame for analysis at 460 and continues at 465. If the user selects an existing model at 450, then the user continues at 465.

The user may then submit the model to the data analysis tools at 470. The analysis model may then be input into the data analysis tools hosted by the central server. Preferably, the analysis tools are off the shelf software or programs which are commercially available from companies such as SAS Institute, SPSS and/or the like. The data analysis tools are preferably capable of providing a variety of analytical approaches to the user or manufacturer. For example, the manufacturer may analyze current market share across all customers, current market share across cardholder customers only, market share trends over time (based on all customers or on cardholder customers only), or other relevant approaches. The user may further analyze prior promotional performance, such as by analyzing market share before, during and after a promotional period, again by all customers or by cardholder customers only. Furthermore, the user may analyze manufacturer coupon issuance and redemption of coupons provided through the coupon distribution system associated with the promotional tools of the present invention. Any of these analyses may be further focused with respect to geographic location, specific retailers or stores, or by calendar week or by accumulated calendar weeks or other time periods. The cardholder data may further be clustered with respect to purchase frequency, average market basket value, and/or coupon usage and the like. Clearly, other queries and forms of analysis may be implemented without affecting the scope of the present invention. The output of the data analysis tools may be downloaded from a global computer network, such as the internet, or otherwise directed to a screen, printer, or file for viewing and further analysis by the user. The user may review and analyze the results at 475. The user then may continue at 415, or quit or log off the network.

After the user sets up or selects the desired analysis model and submits the model to the analysis tools, the user may analyze the results to determine what promotional content and time period may be desirable. Preferably, the user will be provided the option of creating a new promotion or altering an existing promotion that has not yet been submitted. The promotion may group a set of offers together that have a common set of targeting criteria and are to be made available during the same promotional period. If the user elects to enter a promotion at 420, then the user may define their promotional content or offer at 480, such as by selecting an existing promotion, editing an existing promotion, or creating a new promotional offer. The promotional content preferably comprises an offer which includes an offer type and value, such as “$ 1.00 off,” “free with this coupon,” “buy one, get one free,” or the like, offer text, which describes in more detail what is being offered, barcode data, which may include extended barcode data, expiration date, and the manufacturer's offer code, which is included for accounting purposes as is known in the art. If the user elects to create a new promotion at 480, then the user defines the offer value at 485 and offer text at 490. The user may further enter the expiration date of the offer at 495 and the user/manufacturer identification data, such as barcode data and the manufacturers' offer code at 500. The user then continues at 505. If the user elects to edit an existing promotion at 480, then the user selects the promotion at 510 and edits the promotion at 515. The user then continues at 505. If the user elects to use an existing promotion at 480, then the user selects the promotion at 520 and continues at 505.

The user may then select the promotional time period during which the coupons will be distributed from the list of those available at 525. The user may optionally select exclusivity in the product category and/or subcategory for the particular promotional offer and time period at 530. Preferably, if exclusivity is selected, exclusivity will only be secured after a predetermined minimum number of coupons are provided within a specified time. This ensures that enough coupons are directed to a large enough portion of the audience, in order to justify the exclusivity request. The user may then submit the promotional offer or offers to the central server at 535. Preferably, either the analysis model or the promotional offer will also identify which particular stores or region of stores will receive the selected offer or offers. After the promotion has been satisfactorily defined by the user, the promotion may be submitted to the central server for processing the selections and distributing the offers to the target audience. Preferably, even after a promotion has been submitted to the central server, the manufacturer may still have the ability to alter or even cancel the promotion within a reasonable amount of time prior to the distribution of the coupons or offers. The promotion may also be expanded with an additional offer or offers prior to distribution.

After the promotional offer and time period are submitted to the central server, the central server forwards this information to the retail servers, as discussed above at step 350 of process 300. The retail servers then receive the offer or offers at 240 of retail server process 200. If the offer is accepted by the retailers, the coupon offers are communicated to the coupon distribution system for distribution during the promotional period. During the promotional period, consumers may obtain the promotional offers or coupons from one or more coupon distribution systems. Once the coupons are obtained, they are preferably immediately redeemable at the participating stores and may be redeemed at any other time during the redemption period prior to the expiration date. After the promotional period is complete and the coupon issuance data are received by the retail server, which transfers the data to the central server, the manufacturer may be invoiced for the number of coupons printed. The manufacturer then may submit payment to the central server host, who then reimburses the retailer for the kiosk participation fee or other participation fees associated with other coupon distribution systems. The retail store submits the redeemed coupons to a clearing house, which then invoices the manufacturer for the redemption value of the coupons and handling fees, as is known in the art.

Accordingly, the present invention provides a coupon ordering and distribution system which allows the product manufacturers to analyze real time data for a selected geographical area and select a promotional content and promotional period based on such analyses. The central server hosting company, such as Ad Response Micromarketing, licenses the right to the product manufacturers to access the analytical software tools available on the central server or internet site or the like. These tools provide the manufacturer the means to conduct analyses on the consolidated data for product movement and consumer purchase patterns within any industry standard, product category or subcategory, and/or freely defined geographical area. The licensed manufacturers may interface or communicate with the coupon order entry or promotional selection software tools to specify the coupon print content, audience selection criteria, geographical area, and time frame for coupon or offer distribution. The coupon specifications may then be communicated to the central server for later distribution to the coupon distribution systems.

Although shown and described as the manufacturer accessing the analytical software tools and promotional selection tools at an internet site, clearly the present invention includes other means for providing the tools to the manufacturers, such as via software discs, direct modem connection to the central server, or any other known communication or data transfer means. The present invention thus allows the individual manufacturers to analyze real time data in making their promotional decisions. The present invention further allows the manufacturers to communicate with the analytical and promotional tools and thus submit promotions without requiring further interaction and negotiations with sales representatives of the various coupon print and distribution companies.

Because the data provided by the present invention are continuously collected by the retail stores and the retail servers, the manufacturers are always provided with up-to-date, real time data, and thus may define and revise their promotional offers and periods throughout the year, rather than making their entire yearly promotional decisions at one time based on the data from the prior year or years. This allows the manufacturers to better focus their promotions on consumers and areas where the promotions will be most effective, thus giving the manufacturers a better return on their promotional dollars spent and providing the consumers with coupons and offers which they will more likely appreciate and utilize.

Changes and modifications in the specifically described embodiments can be carried out without departing from the principles of the invention, which is intended to be limited only by the scope of the appended claims, as interpreted according to the principles of patent law.

The embodiments of the invention in which an exclusive property right or privilege is claimed are defined as follows:

1. A method for generating coupons in response to a product manufacturer's input, said method comprising:
collecting consumer data associated with at least one particular consumer in response to a consumer input associated with at least one particular consumer at at least one store;
collecting product movement data associated with products being sold at the at least one store;
providing said consumer data and said product movement data to at least one product manufacturer;
providing promotion selection tools to the at least one product manufacturer to allow the at least one product manufacturer to analyze said consumer data and said product movement data and to select a selected promotional content and a selected promotional time period for a desired promotion in response to the analysis;
receiving said selected promotional content and said selected promotional time period from the product manufacturers; and
generating coupons corresponding to said selected promotional content during said selected promotional time period.

2. The method of claim 1, wherein said step of generating coupons is performed by a coupon generating system which generates coupons corresponding to said selected promotional content during said selected promotional time period in response to a user input at the coupon generating system.

3. The method of claim 2, wherein said coupon generating system comprises at least one kiosk positioned at the at least one store.

4. The method of claim 1 including consolidating said consumer data and said product movement data into consolidated data and wherein providing said consumer data and said product movement data comprises providing said consolidated data to the at least one product manufacturer, said consolidated data being consolidated by specified criteria into a database and reformatted for analytical purposes.

5. The method of claim 4, wherein said specified criteria comprise at least one of a time period, a geographical area, consumer behavior, anonymous versus identifiable consumers, purchase frequency, purchase amount, product category, coupon issuance, coupon redemption and market share.

6. The method of claim 1, wherein collecting consumer data comprises collecting consumer purchase data associated with particular consumers in response to identifying the particular consumers at at least one of a point of sale device at the at least one store and at least one kiosk at the at least one store, said consumer data comprising consumer identification data and consumer purchase data associated with transactions made by the particular consumer at the at least one store.

7. The method of claim 6 including separating said consumer identification data from said consumer data and providing said consumer purchase data to the at least one product manufacturer.

8. The method of claim 7, wherein collecting product movement data comprises collecting product movement data at a point of sale device at the at least one store.

9. The method of claim 8, wherein collecting product movement data comprises collecting at least one of product sale data, coupon issuance data and coupon redemption data.

10. The method of claim 1, wherein providing said promotion selection tools comprises providing promotion selection tools to at least one product manufacturer via a network server, said network server receiving said selected promotional content and said selected promotional time period and communicating said selected promotional content and said selected promotional time period to said coupon generating system via electronic media.

11. The method of claim 10, wherein providing said consumer data and said product movement data comprises providing said consumer data and said product movement data to the at least one product manufacturer via said network server.

12. The method of claim 1, wherein providing said promotion selection tools comprises providing modeling tools for modeling promotions based on said consumer data and said product movement data and providing selection tools for selecting the desired promotional content and promotional time period for the promotion based on the models.

13. The method of claim 1 including revising at least one of said selected promotional content and said selected promotional time period by the at least one product manufacturer after said selected promotional content and said selected promotional time period have been received.

14. The method of claim 13, wherein revising at least one of said selected promotional content and said selected promotional time period and receiving the at least one of revised promotional content and the revised promotional time period are accomplished via electronic media.

15. A product manufacturer directed coupon ordering system comprising:
a consumer data collecting device operable to collect consumer data associated with particular consumers in response to a consumer input by the particular consumers at at least one store;
a product movement data collecting device operable to collect product movement data associated with at least some products being sold at the at least one store;
analysis tools for analyzing said product movement data and said consumer data, said analysis tools being accessible by at least one product manufacturer remote from the at least one store;
promotion selection tools for selecting a promotional content and a promotional time period, said promotion selection tools being accessible by the at least one product manufacturer remote from the at least one store, said analysis tools and said promotion selection tools being selectably operable to analyze said product movement data and said consumer data and to generate a selected promotional content and a selected promotional time period in response to an input by the at least one product manufacturer; and
a coupon generating system operable to generate coupons corresponding to said selected promotional content during said selected promotional time period in response to said selected promotional content and said selected promotional time period being communicated to said coupon generating system.

16. The product manufacturer directed coupon ordering system of claim 15, wherein said coupon generating system comprises at least one of a point of sale device at the at least one store and a kiosk positioned at the at least one store, said coupon generating system being operable to generate coupons in response to a user input at said at least one of said point of sale device and said kiosk.

17. The product manufacturer directed coupon ordering system of claim 16, wherein said consumer data collecting device comprises at least one of said point of sale device and said kiosk.

18. The product manufacturer directed coupon ordering system of claim 17, wherein said user input comprises an identification of the particular consumer at said at least one of said point of sale device and said kiosk.

19. The product manufacturer directed coupon ordering system of claim 17, wherein said product movement data collecting device comprises at least one of said point of sale device and said kiosk.

20. The product manufacturer directed coupon ordering system of claim 17, wherein said consumer data collecting device is operable to collect said consumer data at least in response to identifying the particular consumers at said at least one of said point of sale device and said kiosk, said consumer data comprising consumer identification data and consumer purchase data associated with transactions made by the particular consumer at the at least one store.

21. The product manufacturer directed coupon ordering system of claim 20, wherein said coupon ordering system is operable to separate said consumer identification data from said consumer data, said consumer identification data being generally inaccessible by said analysis tools and said promotion selection tools.

22. The product manufacturer directed coupon ordering system of claim 15, wherein said analysis tools and said promotion selection tools are provided to the at least one product manufacturer via a network server.

23. The product manufacturer directed coupon ordering system of claim 22, wherein said analysis tools and said promotion selection tools are accessible by the at least one product manufacturer via electronic media, said selected promotional content and said selected promotional time period being communicated to said coupon generating system via electronic media.

24. The product manufacturer directed coupon ordering system of claim 22, wherein said network server is operable to consolidate said consumer data and said product movement data into consolidated data and to provide said consolidated data to the at least one product manufacturer, said consolidated data being consolidated by specified criteria into a database and reformatted for analytical purposes.

25. The product manufacturer directed coupon ordering system of claim 24, wherein said specified criteria comprise at least one of time period, geographical area, consumer behavior, anonymous versus identifiable consumers, purchase frequency, purchase amount, product category, coupon issuance, coupon redemption and market share.

26. The product manufacturer directed coupon ordering system of claim 15, wherein said promotion selection tools comprise a modeling program for modeling promotions based on outputs from said analysis tools and a selection program for selecting the desired promotional content and promotional time period for the promotion based on the models.

27. The product manufacturer directed coupon ordering system of claim 15, wherein said promotion selection tools are accessible by the at least one product manufacturer to revise at least one of said selected promotional content and said selected promotional time period to generate at least one of a revised promotional content and a revised promotional time period, said at least one of a revised promotional content and a revised promotional time period being communicatable to said coupon generating system after said selected promotional content and said selected promotional time period have been communicated to said coupon generating system.

28. A method for generating coupons in response to a product manufacturer's input comprising:
collecting consumer data associated with particular consumers in response to receiving a consumer identification input associated with particular consumers at at least one store, said consumer data being collected at a kiosk positioned at the at least one store;
collecting product movement data associated with at least some products being sold at the at least one store, said product movement data being collected at a point of sale device positioned at the at least one store;
consolidating said consumer data and said product movement data into consolidated data;
providing promotion selection tools accessible by the at least one product manufacturer, said promotion selection tools allowing the at least one product manufacturer to access said consolidated data via electronic media and to analyze said consolidated data and to select a selected promotional content and a selected promotional time period for a desired promotion in response to the analysis;
communicating the selected promotional content and the selected promotional time period at least to said kiosk via electronic media; and
generating coupons corresponding to the selected promotional content during the selected promotional time period, said coupons being generated at least at said kiosk in response to said consumer identification input at said kiosk.

29. The method of claim 28, wherein the at least one product manufacturer accesses said promotion selection tools via a global computer network, the selected promotional content and the selected promotional time period being communicated to said kiosk via the global computer network.

30. The method of claim 28, wherein consolidating said consumer data and said product movement data comprises separating consumer identification data from said consumer data before said consumer data is accessed by said promotion selection tools.

31. A product manufacturer directed coupon ordering system comprising:
at least one kiosk positionable at at least one store, said at least one kiosk being operable to collect consumer data associated with particular consumers in response to a consumer identification input by particular consumers at said at least one kiosk;
at least one point of sale device positionable at the at least one store, said at least one point of sale device being operable to collect product movement data associated with at least some products being sold at the at least one store;
a server operable to consolidate said consumer data and said product movement data into consolidated data;
modeling tools for accessing and analyzing said consolidated data and for modeling promotions based on said consolidated data, said modeling tools being accessible by at least one product manufacturer via electronic media; and
promotion selection tools for selecting a selected promotional content and a selected promotional time period based on an output of said modeling tools and in response to a user input by the at least one product manufacturer, said promotion selection tools being accessible by at least one product manufacturer via electronic media, wherein said at least one kiosk is operable to receive said selected promotional content via electronic media, said at least one kiosk being operable to generate coupons corresponding to said selected promotional content during said selected promotional time period at least in response to identification of particular consumers at said at least one kiosk.

32. The product manufacturer directed coupon ordering system of claim 31, wherein the at least one product manufacturer accesses said modeling tools and said promotion selection tools via a global computer network, said selected promotional content being communicated to said at least one kiosk via the global computer network.

33. The product manufacturer directed coupon ordering system of claim 31, wherein said server is operable to separate consumer identification data from said consumer data when consolidating said consumer data and said product movement data into said consolidated data.
